(19) United States
(12) Patent Application Publication
(10) Pub. No.: US 2004/0125801 A1
(43) Pub. Date: Jul. 1, 2004

(54) Intermediary device and forwarding method

(76) Inventor: Akihiro Nawata, Fukuoka (JP)

Correspondence Address: RATNERPRESTIA, P O BOX 980, VALLEY FORGE, PA, 19482-0980, US

(21) Appl. No.: 10/668,893

(22) Filed: Sep. 23, 2003

(30) Foreign Application Priority Data
Sep. 27, 2002 (JP) 2002-283158

(51) Int. Cl. H04L 12/56

(52) U.S. Cl. 370/389

(57) ABSTRACT

A intermediary device relays a data packet communicated between two networks. The intermediary device extracts a host name from the data packet transmitted from a transmission-source network, and translates the host name to an address in a transmission-destination network. This function allows an access to a plurality of servers in the transmission-destination network with respective host names. When the transmission-source network is a wide area network, address independent access is allowed because the host name is always constant even if a global IP address is updated. A directory can be placed after the host name, so that a common directory can be used for the plurality of terminals.

### TECHNICAL FIELD

The present invention relates to an intermediary device (router) for determining a local Internet Protocol (IP) address for forwarding based on a host name added from a browser, an intermediary device for relaying data between networks, and a forwarding method using the intermediary devices.

### BACKGROUND ART

Recently, for aiming at always-on connections to a wide area network such as the Internet, Asymmetric Digital Subscriber Line (ADSL) and Cable Television Internet (CATV) have become fully widespread, and broadband routers also have become extremely widespread. FIG. 9 is a block diagram of a network system including a router having a conventional host name forwarding function. FIG. 10 is a conventional port-forwarding setting table. In FIG. 9 and FIG. 10, router 102 has a plurality of ports on the Local Area Network (LAN) side and a port on the Wide Area Network (WAN) side. The WAN is connected to Internet 101. In FIG. 9, two servers 103, 104 are connected to the LAN side of router 102. Server 103 is set to have input/output port number “80” and local IP address “192.168.0.255”, and Server 104 is set to have input/output port number “81” and local IP address “192.168.0.256”. Such a router of which WAN-side port is connected to the Internet and LAN-side ports are connected to a plurality of user devices prevails.

Present IP protocol IPv4 incidentally has a want of absolute number of global IP addresses. Using a Network Address Translation (NAT) function or a port forwarding function (static IP masquerade function) supplies the want of the global IP addresses. When a LAN-side device accesses Internet 101, the NAT function is used for translating the local IP address of the LAN-side device into a WAN-side global IP address of router 102. The port forwarding function (static IP masquerade function) of router 102 allows an external terminal on the Internet 101 to access a specific device on the LAN side.

For using the port forwarding function, as shown in FIG. 10, a translation table of a port number and local IP addresses must be previously set in router 102. An external terminal, in accessing a device from Internet 101, specifies the global IP address and the port number of router 102. On accepting this access, router 102 translates the global IP address into a local IP address based on the previously set translation table. The external terminal on Internet 101 can access one device having the local IP address in the LAN through the translation.

When two servers 103, 104 are connected to the LAN side of router 102 as shown in FIG. 9, for example, the port forwarding setting is previously applied to router 102 as discussed above. When a user accesses server 103 from an external terminal on Internet 101, the user inputs “:80/” in the last part of the Uniform Resource Locator (URL) on the browser of the external terminal to specify input/output port number “80”. In other words, the user inputs “http://serverA.server.net:80/”. When the user accesses server 104, similarly, the user inputs “http://serverA.server.net:81/”. A Domain Name System (DNS) server (not shown) on Internet 101 translates the URL into a global IP address of router 102 based on the input to allow access to the router. Router 102 forwards the access to each of ports “80” and “81” to each of local addresses “192.168.0.255” and “192.168.0.256” based on the translation table, thereby allowing the external terminal to access each of servers 103, 104. For accessing each of servers 103, 104 from Internet 101 by the port forwarding function, port numbers must be allocated to respective servers without duplication.

Conventional router 102 connects a plurality of user devices to the Internet while moderating exhaustion of the global IP addresses by the port forwarding function and the NAT function as described above. The user must therefore recognize the port number of the LAN-side device and follow the change.

Present IP protocol IPv4 has a small number of global IP addresses, so that in most cases the global IP addresses are not fixed but dynamically allocated by a Dynamic Host Configuration Protocol (DHCP) server at the starting time of a client, for example. In a case of access from the outside, using a host name facilitates recognition and access. When there is no Dynamic Domain Name System (DDNS) server for making the continuously updated global IP addresses correspond to the host manes, however, access with the host names is not allowed.

On the other hand, Japanese Patent Unexamined Publication No. 2001-345841 proposes a communication network system for allowing one-to-one communication between a terminal managed with a global IP address and a terminal managed with a private IP address using a directory. This system has an intermediary means between a public communication network such as the Internet and a private network. The intermediary means identifies an identifier of a terminal connected to the private network as a directory (sub-address). The intermediary means issues an access request from the outside to individual terminals distributed in a private address space. This configuration and a method such as NAT and IP masquerade are concurrently used. This system allows the one-to-one communication between an Internet terminal managed with a global IP address and a private network terminal managed with a private IP address.

However, the system uses a directory as the identifier, so that terminals having a different directory can be recognized only when host names are registered in the same DDNS server. The system must therefore have the DDNS server in the private network.

Using this system a user can access to a device on the LAN side without using any port number, but is required to input of a host name and a directory in succession because the system uses the directory as the identifier. The host names are forced to be the same in themselves. Therefore, when a plurality of devices are connected on the LAN side, different host names cannot be provided for the devices.

Additionally, the system uses a directory structure. Therefore, when access “http://www.carrier.ne.jp/ab001/index.html”, for example, is permitted, a terminal under the router (intermediary means) recognizes that file “ab001/index.html” is required. The terminal extracts “index.html” from directory “ab001” and transmits it to the access source. This terminal must therefore have directory “ab001” in the same structure. In other words, web page “index.html” must be set in directory “ab001” in the terminal. However, directories of a sizable percentage of commercially offered terminals cannot be changed, so that usable terminals are limited and general versatility is lost even when this structure is employed.

### DISCLOSURE OF THE INVENTION

The present invention provides an intermediary device that is disposed between a first network and a second network and relays a data packet communicated between the first network and the second network. The intermediary device has the following elements:

a host name detecting unit for extracting a host name from a packet received from the first network; and

a translation table storing unit that stores a translation table for making host names correspond to addresses in the second network. The extracted host name is translated into an address in the second network with reference to the translation table.

### BRIEF DESCRIPTION OF THE DRAWINGS

FIG. 1 is a block diagram of a network system allowing an access to a server under a router in accordance with exemplary embodiment 1 of the present invention.

FIG. 2 is a host-name forwarding table in accordance with exemplary embodiment 1.

FIG. 3 shows a Hyper Text Transport Protocol (HTTP) request header in accordance with exemplary embodiment 1.

FIG. 4 is a sequence chart showing an access by a system having the router in accordance with exemplary embodiment 1.

FIG. 5 is a flow chart of processes of the router in accordance with exemplary embodiment 1.

FIG. 6 is a block diagram of a network system allowing an access to a server under a router in accordance with exemplary embodiment 2 of the present invention.

FIG. 7 is a sequence chart of the network system during the access to a terminal under the router in accordance with exemplary embodiment 2 of the present invention.

FIG. 8 is a block diagram of a network system allowing an access to a server between two networks via a router in accordance with exemplary embodiment 3 of the present invention.

FIG. 9 is a block diagram of a router having a conventional host name forwarding function.

FIG. 10 is a conventional port-forwarding setting table.

### DETAILED DESCRIPTION OF PREFERRED EMBODIMENTS

(Exemplary Embodiment 1)

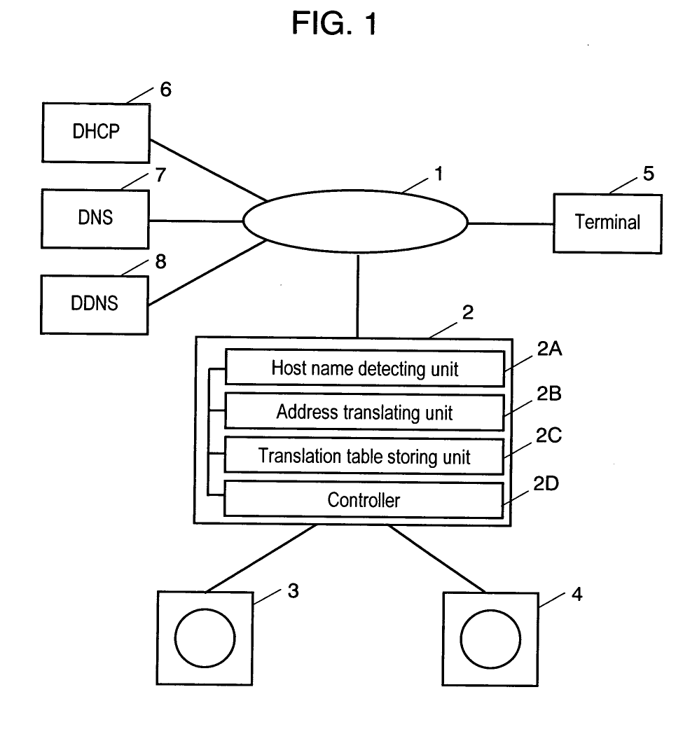

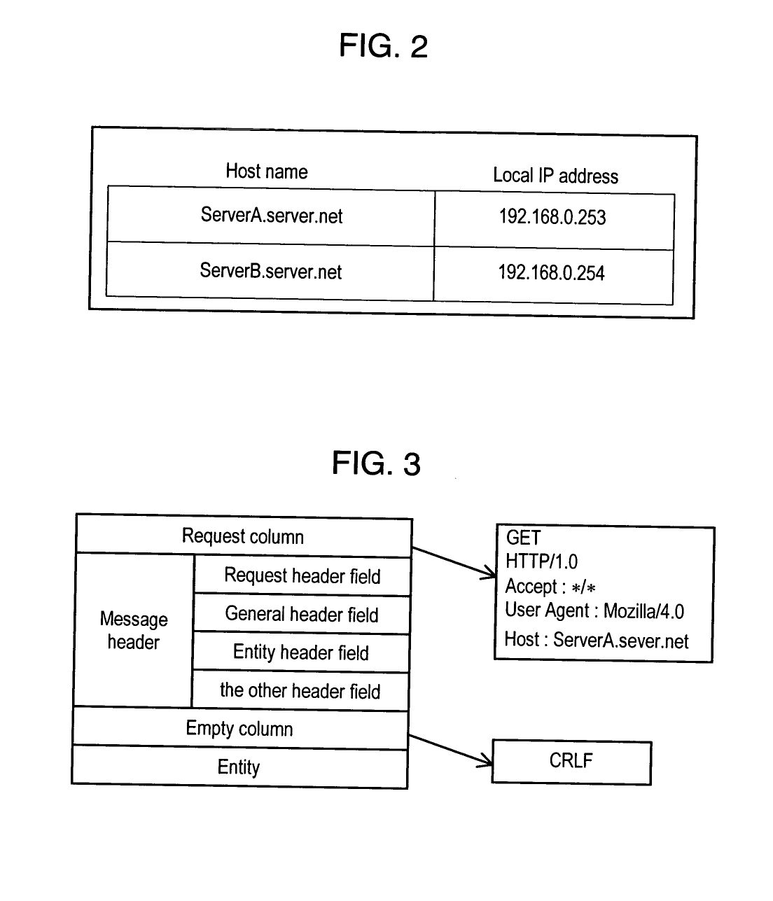

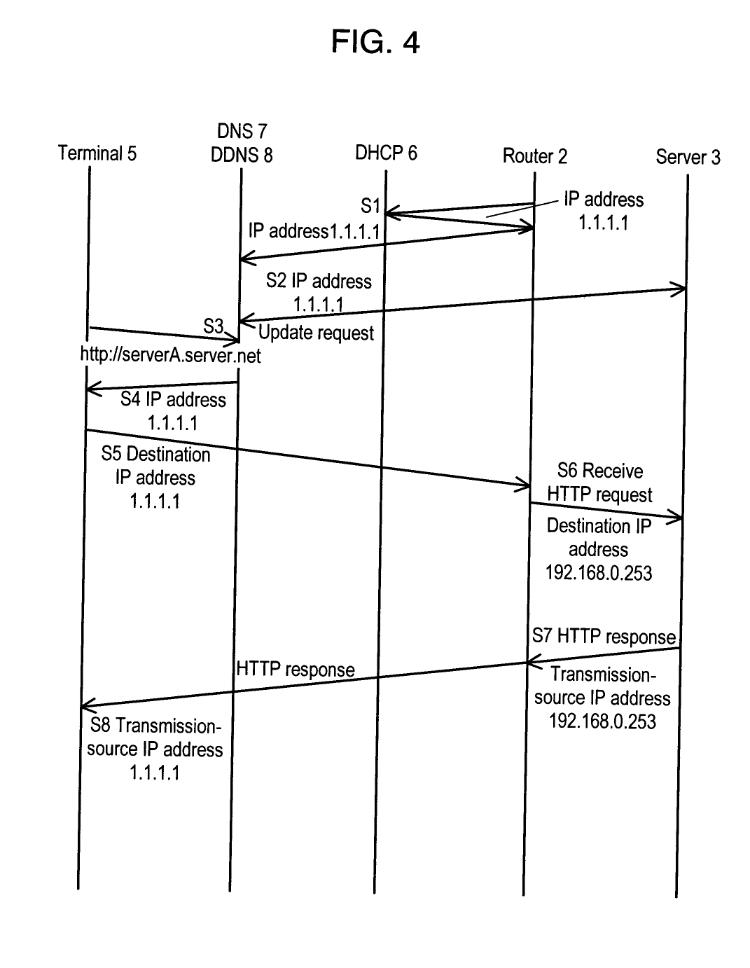

FIG. 1 is a block diagram of a network system allowing an access to a terminal under a router in accordance with exemplary embodiment 1 of the present invention. FIG. 2 is a host-name forwarding table. FIG. 3 shows an HTTP request header. FIG. 4 is a sequence chart showing the access by a system having the router in accordance with the present embodiment.

Router (intermediary device) 2 is connected to Internet 1 as a wide area network, and a Local Area Network (LAN) is formed under router 2. Router 2 has an interface connectable to Internet 1 and a plurality of ports on the LAN side, and performs routing between devices (servers 3, 4) under router 2 and Internet 1.

Host name detecting unit 2A disposed in router 2 extracts a host name from the HTTP header of an IP packet (data packet) received from Internet 1. Controller 2D refers to the host name forwarding table (it is hereinafter called a translation table) stored in translation table storing unit (it is hereinafter called storing unit) 2C. And controller 2D determines whether or not the host name extracted by host name detecting unit 2A matches with each host name in the translation table. When a host name matching with the extracted host name exists in the table, controller 2D extracts a local IP address corresponding to the host name from storing unit 2C. Address translating unit (it is hereinafter called translating unit) 2B replaces a destination address of the received IP packet with the extracted local IP address. Router 2 transmits the IP packet to the LAN side using the local IP address. Router 2 is a broadband router in the present embodiment.

In FIG. 1, two servers 3, 4 are connected to the LAN side of router 2. The host name of server 3 is set at “ServerA.server.net”, the host name of server 4 is set at “ServerB.server.net”, and these host names are managed by DDNS server 8. Both input/output port numbers of servers 3, 4 are set at “80”.

Router 2 has the translation table shown in FIG. 2 in storing unit 2C. The translation table shows correspondences between the host names and the local IP addresses on the LAN side. In the example of FIG. 2, the local IP address corresponding to host name “ServerA.server.net” is “192.168.0.253”, and the local IP address corresponding to host name “ServerB.server.net” is “192.168.0.254”.

External terminal 5 is connected to Internet 1. Dynamic Host Configuration Protocol (DHCP) server 6 allocates a global IP address of predetermined global IP addresses to terminal 5. Domain Name System (DNS) server 7 sends the global IP address to respond to access using a host name. Dynamic Domain Name System (DDNS) server 8 makes the host name correspond to the global IP address determined by DHCP server 6.

Operations of router 2 are hereinafter described in the case in which terminal 5 accesses server 3. Firstly, an HTTP request (data packet) is transmitted through a browser from terminal 5 to server 3 on Internet 1. Host name detecting unit 2A extracts the host name of server 3 from the HTTP request header of the data packet, and translating unit 2B translates the host name into the local IP address. Router 2 routes the data packet received from terminal 5 to server 3 of the local IP address. For example, terminal 5 transmits an HTTP request to server 3. The HTTP request has global IP address “1.1.1.1” in a destination IP address and host name “ServerA.server.net” in the HTTP request header. Router 2 routes the HTTP request to server 3. When terminal 5 accesses server 4, router 2 operates similarly.

The HTTP request is described in more detail. When terminal 5 issues the HTTP request to server 3 as shown in FIG. 3, Uniform Resource Identifier (URI) and version information “HTTP1.0” are written after method “GET”. The host name is written after “Host”. Column “CRLF” is written finally, then terminal 5 requests a file of server 3. The host name is thus automatically written into a request column of the HTTP request header, so that host name detecting unit 2A extracts the host name and translating unit 2B translates it into the local IP address.

A series of basic processing which includes the HTTP request to server 3 and a response to it is then described with reference to FIG. 4.

Firstly, in S1, router 2 requests DHCP server 6 to send a global IP address, and DHCP server 6 allocates global IP address “1.1.1.1” to router 2 with a time limit. Router 2 informs DDNS server 8 of global IP address “1.1.1.1” and host name “ServerA.server.net” of server 3. Router 2 also informs DDNS server 8 of same global IP address “1.1.1.1” and host name “ServerB.server.net” of server 4. Router 2 has a mode setting function of a translation mode with a host name. Router 2 issues a DDNS setting request in the present embodiment; however, server 3 and server 4 instead of router 2 may issue a DDNS setting request to respective routers 2. For example, in S2, server 3 requests an update of DDNS server 8, and the request is sent to DDNS server 8 through router 2.

In S3, terminal 5 inquires a global IP address of DDNS server 8 (DNS server 7) by specifying “http://ServerA.server.net” in the URI using a browser. DNS server 7 inquires the global IP address of DDNS server 8. DDNS server 8 instantly answers the inquiry to send global IP address “1.1.1.1” corresponding to host name “ServerA.server.net”. In S4, DNS server 7 answers terminal 5.

Terminal 5, on receiving global IP address “1.1.1.1” of router 2, accesses server 3 via the HTTP in S5. Terminal 5 saves global IP address “1.1.1.1” and “80” into the destination IP address and the destination port number, respectively, and transmits the IP packet to Internet 1. In the IP packet, the HTTP header shown in FIG. 3 is set in the data region. The port numbers of both server 3 and server 4 can be set at common “80”, differently from the conventional port forwarding function.

Router 2 receives the transmitted IP packet in S6. Router 2 extracts host name information from the IP packet with host name detecting unit 2A, and refers to a routing table (not shown) to recognize that the host name indicates server 3 thereunder. Router 2 then refers to the translation table in storing unit 2C, and translates the destination address from the global IP address to local IP address “192.168.0.253” shown in FIG. 2 with translating unit 2B. Router 2 then transfers the HTTP request to server 3.

Local IP address “192.168.0.253” corresponds to host name “ServerA.server.net”, and local IP address “192.168.0.254” corresponds to host name “ServerB.server.net” in the translation table shown in FIG. 2. Router 2 translates host name “ServerA.server.net” into local IP address “192.168.0.253”, and then issues the HTTP request having “192.168.0.253” in the destination IP address to server 3 in S6.

In S7, server 3 transmits a response to terminal 5. When server 3 transmits a packet having “192.168.0.253” set in the transmission-source IP address, router 2 receives this packet. In S8, on recognizing that the packet is a response to terminal 5, router 2 refers to the routing table (not shown), sets, as the transmission-source IP address, global IP address “1.1.1.1” allocated to router 2 at that time, and transmits the IP packet. The browser of terminal 5 as the destination receives the IP packet. Terminal 5 can thus communicate with a device such as server 3 in the LAN via Internet 1.

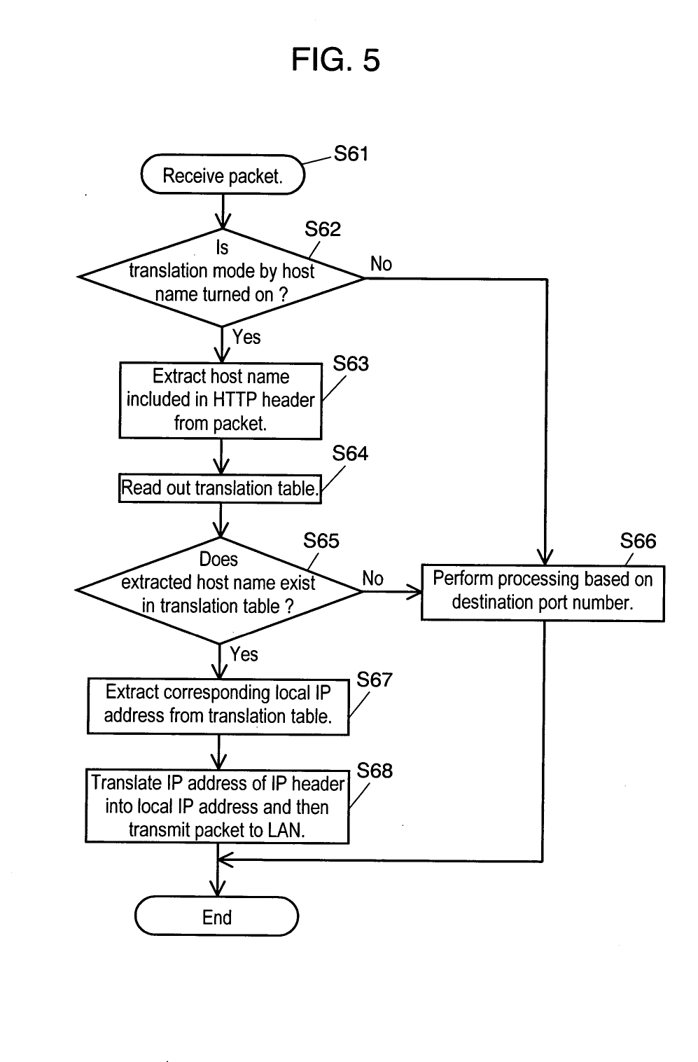

FIG. 5 is a flow chart showing processes by controller 2D in router 2 in more detail. When router 2 receives the IP packet (S61), it is checked whether or not router 2 is set in the translation mode by a host name (S62). When router 2 is set in the translation mode, router 2 extracts the host name included in the HTTP header from the IP packet (S63). When router 2 is not set in the translation mode, router 2 performs processing (port forwarding function or the like) of the IP packet based on the destination port number (S66). On extracting the host name, router 2 reads out the translation table (S64) and checks whether or not the extracted host name exists in the translation table (S65). Storing unit 2C of router 2 previously stores the translation table shown in FIG. 2 showing correspondence between the host names and local IP addresses on the LAN side, as discussed above. In the present embodiment, each global IP address is related to them. When the host name exists in the translation table, controller 2D extracts the corresponding local IP address from storing unit 2C (S67). When the host name does not exist in the translation table, the process proceeds to S66. In S66, processing based on the destination port number is performed. In S67, router 2 replaces the destination IP address of the IP header in the received data packet by the extracted local IP address, and transmits the data packet as the HTTP request to the LAN.

Router 2 of the present embodiment thus extracts the host name written in the HTTP request header and translates the host name into the local IP address. Terminal 5 can therefore, access a plurality of servers 3, 4 with the host name including the domain name as usual. Even when using the DHCP server causes successive updates of the global IP address in the DDNS server, the access is allowed without being affected by the updates. Additionally, a common directory can be used for the plurality of servers.

Router 2 is required to simply change the destination IP address of the IP packet transmitted from the browser without translation of data in an application layer. Router 2 can perform communication in a simple configuration. In other words, a terminal on a client side can directly access a terminal under the router only with a host name. The terminal on the client side does not need to change the HTTP header and employ a directory structure on the server side.

(Exemplary Embodiment 2)

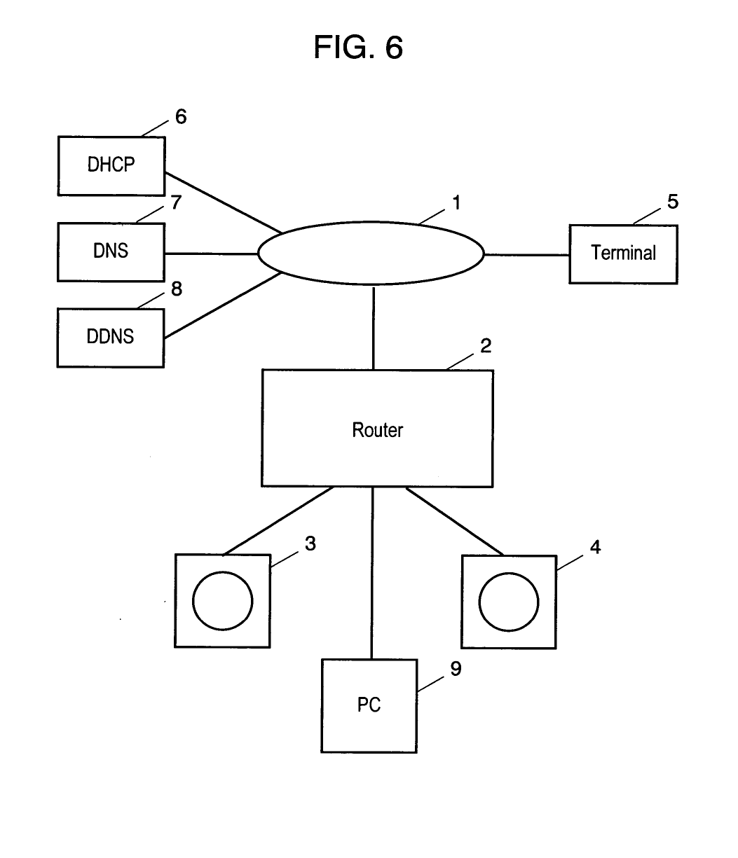

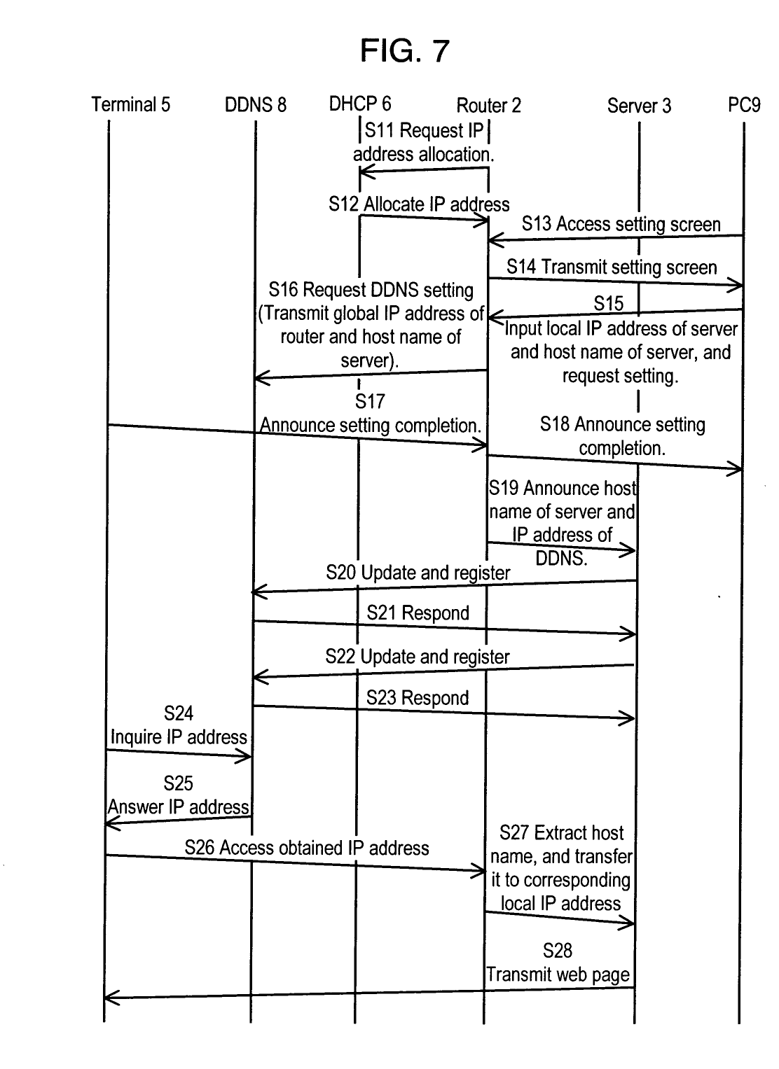

FIG. 6 is a block diagram of a network system allowing an access to a terminal under a router in accordance with exemplary embodiment 2 of the present invention. FIG. 7 is a sequence chart of the network system during the access via the router to a terminal under the router. In the network system of the present embodiment, personal computer (PC) 9 placed under the router sets the host names and the local IP addresses of servers 3, 4. Thus, all elements including DHCP server 6 and DDNS server 8 are automatically set. Processing contents of router 2 in the present embodiment are similar to those in embodiment 1, and an automatically setting function is added in the present embodiment.

In FIG. 7, firstly, router 2 requests, in a broadcast, DHCP server 6 to allocate a global IP address (S11). DHCP server 6, on receiving the request, allocates the global IP address to router 2 (S12). PC 9 for managing server 3 in this state accesses setting screen data of router 2 (S13). Router 2 accordingly transmits the setting screen data to PC 9 (S14). A user of PC 9 inputs the host name and the local IP address of server 3 from the setting screen (not shown), and PC 9 transmits a setting request for server 3 to router 2 (S15).

Router 2, on receiving the request, informs DDNS server 8 of the global IP address allocated to router 2 and the host name of server 3 to request DDNS setting (S16). After the setting, DDNS server 8 sends a setting completion notice to router 2 (S17). Router 2 transmits the setting completion notice to PC 9 (S18), and informs server 3 of the host name and the global IP address of the DDNS server (S19). Through these processes, setting of the host name and the address from PC 9 to server 3 and registering of server 3 into DDNS server 8 are terminated.

Then, server 3 requests DDNS server 8 to update and register (S20). The request for the update and registration is transmitted to DDNS server 8 after the NAT function of router 2 translates the transmission-source IP address of the IP packet from the local IP address of server 3 to the global IP address. DDNS server 8, on receiving the DDNS update request including the global IP address and the host name, performs the update and registration and returns a response message (S21). When the power supply of server 3 is turned off with a transmitted timing of the response message, for example, server 3 repeatedly requests the update and registration of DDNS server 8 after a lapse of a predetermined time without receiving the response message from DDNS server 8 (S22). DDNS server 8 performs the update and registration on receiving every request, and returns the response message (S23). Now, a state is provided where server 3 can translate the address with the global IP address of the router 2 and the host name of server 3.

When terminal 5 on a wide area network accesses server 3 through the browser at a certain time, terminal 5 inquires the global IP address of DDNS server 8 with the host name of server 3 (S24). DDNS server 8 returns the global IP address of router 2 in response to the inquiry (S25). Terminal 5, after receiving the global IP address, accesses the global IP address through the browser (S26), namely translates an HTTP request. Router 2 then receives the access. Router 2 extracts the host name from the HTTP header, sets the corresponding local IP address in the HTTP header, and transfers the HTTP request into the LAN (S27). Server 3 receives it and transmits a requested web page (S28).

In the network system of the present embodiment, PC 9 can manage servers 3, 4 under router 2 to automatically set, update, and register the addresses, and terminal 5 on the wide area network can access server 3 with a host name.

Server 3 requests the update and registration of the DDNS in the present embodiment; however, router 2 may request the update and registration of the DDNS. In the latter case, automatic setting is allowed only by providing router 2 with such an automatic setting function, and general-purpose server 3 can be employed.

In other words, for changing the host name, the translation table in storing unit 2C is changed. Regarding DDNS server 8, router 2 changes the host name corresponding to the global IP address, or PC 9 changes the host name via router 2. The change of the host name is thus easy. Even when the host name is changed, a plurality of terminals can use a common directory.

(Exemplary Embodiment 3)

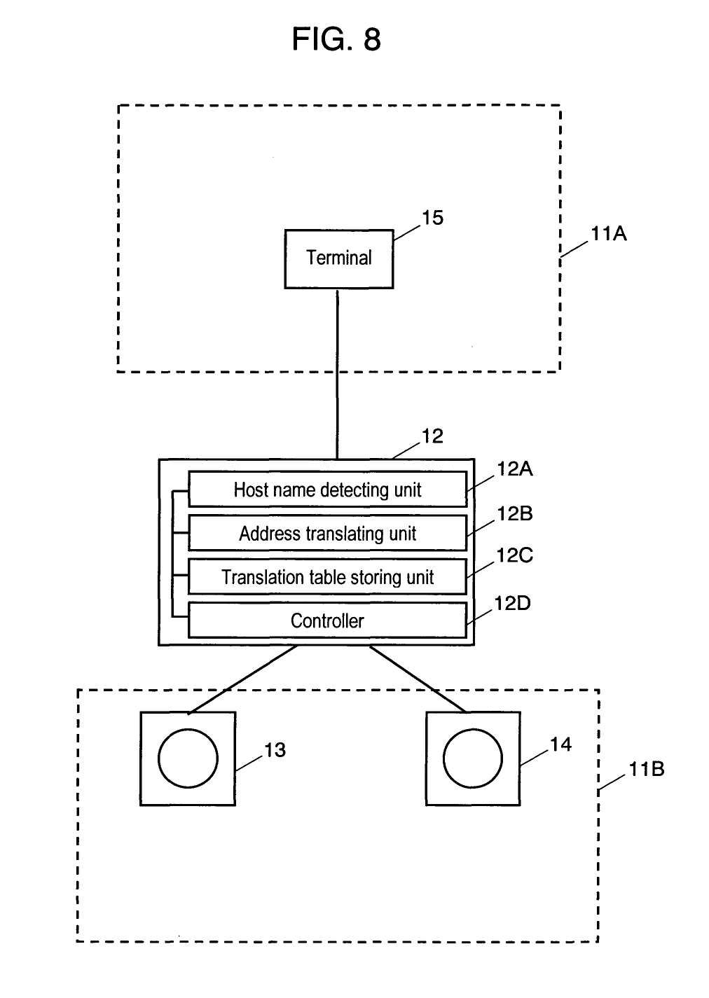

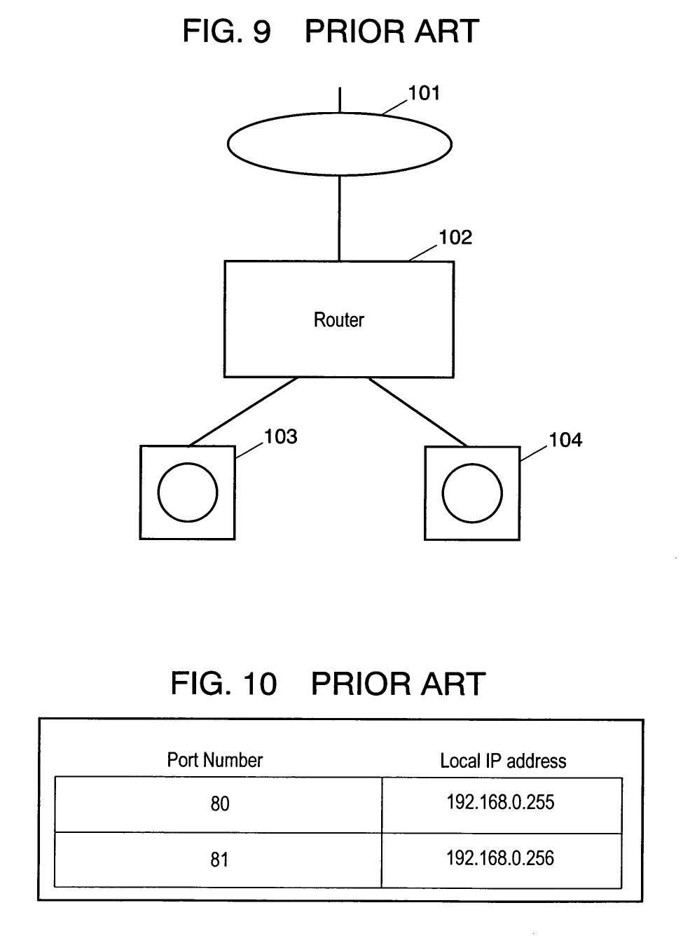

FIG. 8 is a block diagram of a network system in which data is relayed by an intermediary device in accordance with exemplary embodiment 3 of the present invention. Intermediary device 12 of the present embodiment is disposed between first network 11A and second network 11B, and relays data packets communicated between first network 11A and second network 11B. The configuration of the intermediary device is similar to router 2 of embodiments 1, 2 for performing forwarding with a host name. Intermediary device 12 includes host name detecting unit 12A, address translating unit (it is hereinafter called translating unit) 12B, translation table storing unit (it is hereinafter called storing unit) 12C for storing a host-name forwarding table (it is hereinafter called a translation table), and controller 12D.

Host name detecting unit 12A extracts a host name from a data packet received through first network 11A. The translation table provides a correspondence between the extracted host name and an address in second network 11B. Controller 12D refers to the translation table, and determines whether or not the host name extracted by host name detecting unit 12A matches with each host name in the translation table. When a host name matching with the extracted host name exists in the table, controller 12D extracts a local IP address corresponding to the host name from storing unit 2C. Translating unit 12B replaces a destination address of the received IP packet with the extracted local IP address. Intermediary device 12 then transmits the IP packet to the other network using this local IP address.

The translation table is the same as that shown in FIG. 2. However, when a plurality of servers 13, 14 exist in second network 11B and intermediary device 12 routes data packets from terminal 15 in first network 11A to server 13 or 14, the translation table previously stores correspondences between host names of respective servers and network addresses in second network 11B.

When terminal 15 in first network 11A accesses server 13 in second network 11B, for example, controller 12D determines whether or not the host name extracted by host name detecting unit 12A matches with each host name in the translation table. When a host name matching with the extracted host name exists in the table, controller 12D extracts, from storing unit 12C, the second network address corresponding to the host name. Intermediary device 12 replaces the destination address of the received data packet with the extracted second network address using address translating unit 12B, and transmits the data packet to second network 11B. Thus, the data packet transmitted by terminal 15 in first network 11A arrives at server 13 corresponding to the host name in second network 11B.

Intermediary device 12 may be provided with a mode setting function of a translation mode with a host name, similarly to embodiment 1. When the intermediary device is not set in the translation mode, processing (port forwarding function or the like) is performed based on a destination port number.

A router or an intermediary device of the present invention determines a local IP address for forwarding using a host name. Access using a host name to each of a plurality of terminals under the router or intermediary device is therefore allowed. Therefore, the host name is always constant even when a global IP address is updated, so that address independent access is allowed. A directory can be placed after the host name, so that a common directory can be used for the plurality of terminals.

What is claim is:

1. An intermediary device disposed between a first network and a second network and for relaying a data packet communicated between the first network and the second network, said intermediary device comprising:
a host name detecting unit for extracting a host name from the data packet transmitted from the first network; and
a translation table storing unit for storing a translation table for making the host name correspond to an address in the second network,
wherein said intermediary device refers to the translation table and translates the extracted host name into the address in the second network.

2. An intermediary device according to claim 1 further comprising:
an address translating unit for referring to the translation table and translating the extracted host name into the address in the second network.

3. An intermediary device according to claim 1,
wherein said intermediary device transmits the data packet to the second network, the address used for the translation in the second network being set at a transmission destination.

4. An intermediary device according to claim 1 further comprising:
a control unit for determining the address in the second network based on the host name with reference to the translation table, and transmitting the data packet to the second network.

5. An intermediary device according to claim 4,
wherein said control unit, on receiving the data packet from the first network, extracts host name information from the data packet and determines the address based on the host name with reference to the translation table when said intermediary device is set in a translation mode by a host name, and performs processing based on a destination port number when said intermediary device is not set in the translation mode.

6. An intermediary device according to claim 1,
wherein the first network is a wide area network, and the address in the second network is a local IP address.

7. An intermediary device according to claim 6,
wherein said intermediary device receives a local IP address and a host name that are inputted from a terminal connected to the second network, and informs a DDNS server connected to the wide area network of a global IP address allocated to said intermediary device and the inputted host name.

8. An intermediary device disposed between a first network and a second network and for relaying a data packet communicated between the first network and the second network, said intermediary device comprising:
a host name detecting unit for extracting a host name from the data packet transmitted from the first network; and
a translation table storing unit for storing a translation table for making the host name correspond to an address in the second network,
wherein said intermediary device receive the data packet from the first network, extracts host name information from the data packet and determines the address based on the host name with reference to the translation table.

9. A forwarding method of relaying a data packet communicated between a first network and a second network, said forwarding method comprising the steps of:
extracting a host name from the data packet;
translating the extracted host name into a corresponding address in the second network; and
transmitting the data packet to the second network, the address used for the translation in the second network being set as a transmission destination.
